(19) United States
(12) Patent Application Publication
(10) Pub. No.: US 2007/0212502 A1
(43) Pub. Date: Sep. 13, 2007

(54) Printed plastic gift bags

(75) Inventor: Mike Hansborough, Avon Lake, OH (US)

Correspondence Address: ROETZEL & ANDRESS, 1375 EAST 9TH STREET, CLEVELAND, OH, 44114, US

(73) Assignee: American Greetings Corporation

(21) Appl. No.: 11/370,529

(22) Filed: Mar. 8, 2006

(51) Int. Cl. B32B 27/32

(52) U.S. Cl. 428/35.2

(57) ABSTRACT

Decorative printed opaque gift bags are made of polyethylene sheet material with a base print layer applied to substantially an entire exterior or interior surface of the bag to decrease transparency of the polyethylene sheet material so that the contents of the bag are not visible for gift carrying and wrapping. The base or first print layer increases the opacity of the polyethylene sheet material of the bag to prevent visual identity of contents of the bag through the thin-film polyethylene sheet material under ambient lighting so that the bag can be effectively used as a gift bag, and provides a base layer on which one more additional layers of print can be applied in the form of indicia and decorative graphics.

### FIELD OF THE INVENTION

The present invention is in the general fields of packaging and printing, and more particularly printed gift packaging materials and products.

### BACKGROUND OF THE INVENTION

Shopping bags made of thin-film polyethylene sheet material are now used extensively in retail sales operations, for carrying goods and for store advertising. The exceptional strength-to-weight ratio of thin-film polyethylene enables bags to be transparent or translucent, yet sufficiently strong to hold contents of substantial weight, and able to bear the printed application of graphics. Thin-film polyethylene sheet material from which bags are made can be printed in single or full color, and this property has been taken advantage of by retailers to print their name on such bags as a form of advertising and marketing. Light colored plastics are best for printing of graphics, yet thin-film bags made of white or light- colored polyethylene are transparent or at least translucent in areas where printed graphics are not applied, and thus do not entirely conceal the contents of the bag. Such bags are especially transparent when the sheet material is held tightly against the contents of the bag, yet moving the sheet material only a few millimeters away from the object renders it not so visible. To make plastic film bags which are not transparent requires the use of a relatively thick gauge sheet, for example 3 mils or greater, which increases the cost of the bag.

For these and other reasons, thin-film polyethylene bags have not been used as concealing gift bags. Thin-film polyethylene bags have not been used as a type of gift packaging or wrapping, in part due to the transparency of the material which is of course undesirable because the contents of the bag are visible through thin-film unprinted polyethylene material. More desirable would be an opaque or substantially opaque bag which has the strength-to-weight advantage of relatively thin-film polyethylene without excessive material thickness and attendant cost. Opacity (“opaque”) is the quality or state of a body that makes it impervious to rays of light, neither transparent nor translucent. In general, relatively thin-film polyethylene sheet material has a fixed practical range of opacity which is not adequate for concealment of contents of a bag. Some polyethylene sheet material appears to be opaque, but when held up against an object is in fact translucent, i.e. at least partially transparent. Without print applied to the material, translucence can only be reduced by greater material thickness, which is not economically practical. This is particularly the case with any type of gift bag which is intended to serve as concealment or wrapping of the contents as a gift. Solid color sheet plastics and particularly darker colors block light transmission, but in thinner gauges still leave the bag contents at least partially visible, especially when pressed closely against the object, such as against the surface of a box. Also, the darker less transparent colors provide only a limited spectrum as a background for printing of color graphics, which limits design possibilities and consumer appeal. As noted, for most applications, it is not practical or cost-effective to reduce transparency or translucence for this purpose by increasing the thickness of the polyethylene or other plastic sheet material. Graphics which are printed on polyethylene bags typically cover only a small portion of the surface area and thus do not alter the overall transparency or translucence of the bag.

### SUMMARY OF THE INVENTION

The present invention is a plastic thin-film material bag, made of high density polyethylene (HDPE), low density polyethylene (LDPE), or a combination or blend or alloy thereof, which bears print on an exterior or interior surface of the bag in an amount sufficient to reduce the transparency or translucence of the material to an extent that the contents of the bag are not visible through the material. The combination of thin-film polyethylene sheet material with a full print layer provides a new type of gift wrapping or packaging which is strong, lightweight, decorative and opaque (non-transparent). Also, by using a bag as both a carrying vessel and decorative concealment, the tedium of paper gift wrapping is avoided. In one embodiment, thin-film polyethylene bags have print on one or more exterior surfaces of the bag in one or more colors. The exterior print on the bag preferably covers substantially an entire exterior or interior surface of the bag. The amount of ink or other print material on the exterior of the bag is sufficient to block light transmission to an extent to visually conceal the contents of the bag so that it can be used as a gift bag. Printing on the exterior of the bag may include multiple layers or areas of print material, such as ink or other material applied as a film layer, including a base layer which covers an entire exterior or interior of the bag, and one or more overprints or additional layers of print or graphic material on less than the entire exterior of the bag. One embodiment is a thin-film polyethylene bag with full-exterior print on an entire exterior surface of the bag, the full exterior print having a density sufficient to reduce transparency or translucence of the bag, or to otherwise make the bag opaque to block transmission of ambient light through the thin-film polyethylene and thereby prevent visual identity of the bag contents under ambient light. In another embodiment, substantially an entire exterior or interior surface of the bag is covered by adjacent or adjoining areas of print which together create a decorative design or pattern and make the bag opaque.

There is further disclosed a printed gift bag for decorative containment and concealment of gifts or other contents, which includes a bag structure made of polyethylene sheet material (HDPE or LDPE or a blend thereof) and having two generally opposed main panels, two generally opposed pleated side panels extending between and connecting sides of the main panels, the main panels and pleated side panels joined together along a common seam to form a closed bottom to the bag which is opposed to an open top defined by aligned edges of the main panels and pleated side panels, exterior surfaces of the main panels and side panels forming a surface of the bag; a first print layer applied to an interior or exterior surface of the bag, the first print layer having a density sufficient to decrease transparency of the polyethylene sheet material of the bag to a level which prevents visual identity of contents of the bag through the polyethylene sheet material under ambient light, and at least one additional or second print layer applied to a surface of the bag and to an area less than an entire surface of the bag, the second print layer being a color different from a color of the first print layer, the second print layer further decreasing transparency of the bag to a light transmission level less than transparency of the bag with the first print layer applied. The second print layer can be applied over the first print layer, on the same side of one of the panels of the bag, or on a side of a panel of the bag opposite to the first print layer.

There is still further disclosed a printed gift bag for decorative containment and concealment of gifts or other contents, which includes a bag structure made of polyethylene sheet material (HDPE or LDPE or a blend thereof) and having two generally opposed main panels, two generally opposed pleated side panels extending between and connecting sides of the main panels, the main panels and pleated side panels joined together along a common seam to form a closed bottom to the bag which is opposed to an open top defined by aligned edges of the main panels and pleated side panels, exterior surfaces of the main panels and side panels forming a surface of the bag; a full print layer applied to an interior or exterior surface of the bag, the full print layer having a density sufficient to decrease transparency of the polyethylene sheet material of the bag to a level which prevents visual identity of contents of the bag through the polyethylene sheet material under ambient light, the full print layer being either a single color over substantially an entire exterior or interior surface of the bag, or a plurality of adjoining printed areas of the same or different colors which together decrease transparency of the bag to a light transmission level less than transparency of the bag with the first print layer applied.

These and other aspects and variations are further described as representative examples of the technology and do not limit or restrict the scope the patent rights.

### DESCRIPTION OF THE FIGURES

FIG. 1 is an elevation view of a printed plastic gift bag of the invention;

FIG. 2 is a side elevation view of a printed plastic gift bag of the invention;

FIG. 3 is a side elevation view of a printed plastic gift bag of the invention;

FIG. 4 is a plan view of an open top of a printed plastic gift bag of the invention;

FIG. 5 is a plan view of the bottom of a printed plastic gift bag of the invention;

FIG. 6A is an elevation view of an alternate embodiment of a printed plastic gift bag of the invention, and

FIG. 6B is a side elevation view of the printed plastic gift bag of FIG. 6A.

### DETAILED DESCRIPTION OF PREFERRED AND ALTERNATE EMBODIMENTS

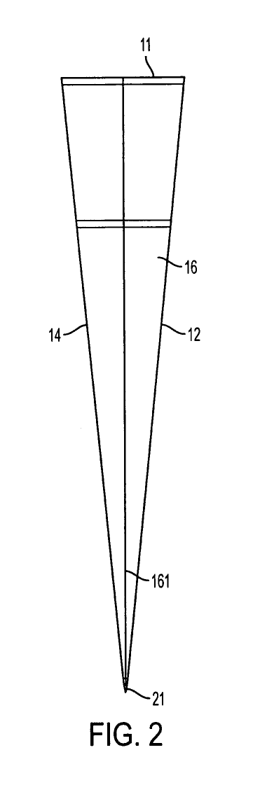

With reference to the Figures, there is illustrated a printed plastic gift bag, indicated generally at 10, which in the particular embodiment shown is in the form of a generally rectangular bag with two main planar panels 12 and 14 (generally opposing panel 12), which are joined together by pleated side panels 16, 18. The main panels 12 and 14 are joined together along seam 21 to form a tapered bottom to the bag as shown in FIG. 2. A fold or pleat 161, 181 in each side panel 16 and 18 extends from an open top 11 of the bag 10 to the tapered bottom at seam 21.

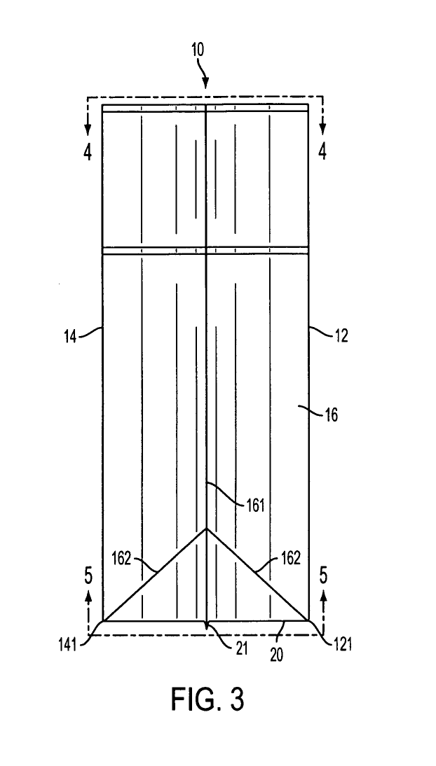

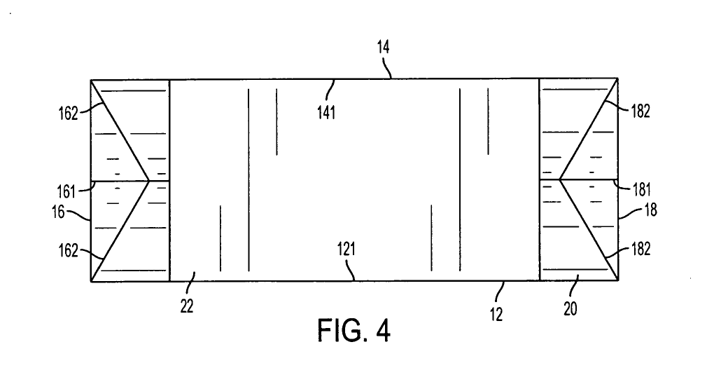

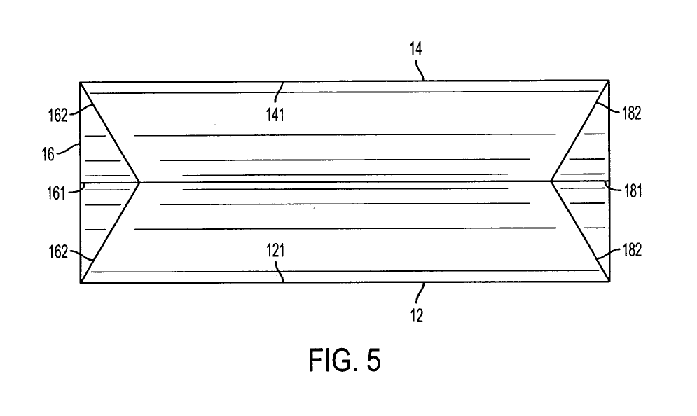

As shown in FIGS. 3-5, an alternative configuration for a printed bag has a generally rectangular bottom panel 20 formed by the lower regions of the main panels 12, 14 which are joined together along seam 21, and creased or folded along lines 121, 141. Gusset folds 162 in panel 16, and 182 in panel 18 extend from the respective creases 161, 181 in the panels 16, 18 to fold lines 121, 141 at the respective edges of the bottom panel 20. When this type of bag construction is made of the described thin-film polyethylene material, the bag easily opens from a folded configuration to the illustrated open configuration with the bottom panel 20 falling into place against a flat supporting surface, or against a planar surface of an object such as a box placed inside the bag. A bottom reinforcement 22 can be inserted to rest on an interior surface of the bottom panel 20, and which also facilitates easy formation of the bag into the open configuration.

Although described with reference to these particular designs or forms, the principles of the invention are applicable to any plastic bag designs or configurations. The material with which bags 10 of the invention are made is referred to herein generally as “plastic sheet material”, which definition includes “thin-film polyethylene sheet material” and “HDPE sheet material”, HDPE/LDPE blends, polypropylene, or any other polymer or plastic or synthetic or paper sheet material or blends of alloys of such materials, and is preferably polyethylene, such as high-density polyethylene (HDPE) in thin sheet form in any suitable gauge thickness. As noted, the polyethylene sheet material may be a blend of HDPE and LDPE, with the LDPE content in any amount up to a maximum of approximately 30%. An excessive amount of LDPE can weaken the bag to an unacceptable extent. A preferred blend for the polyethylene sheet material is approximately 70% HDPE and 30% LDPE, although as noted the LDPE content may be less than 30%. A more preferred blended material for the polyethylene sheet material is 76% HDPE and 24% LDPE. The invention is not limited to any particular plastic or polymeric material in any particular thickness gauge, so long as the material is able to be printed upon an exterior or interior surface in accordance with the invention. A preferred sheet material thickness is in the approximate range of 3 mils or less, in order to take advantage of material cost savings yet retain sufficient load carrying and print bearing capacity.

For pigmented plastic sheet material, the pigment load can be selected or adjusted to set the degree of light transmission, from transparent to translucent to opaque. Pigment additives represent an additional cost to the basic polyethylene material and there are physical limits to the amount of pigment which can be added without deteriorating the strength properties of the polyethylene. In a particular embodiment, to provide a white background for the first print layer on the exterior or interior surfaces of the panels of the bag, including full color printing, a percentage of white pigment is added to polyethylene sheet material from which the bags are made, in an amount sufficient to decrease the transparency and translucence of the sheet material, rendering it substantially opaque without adversely effecting the physical properties of the material. The pigment load can be, for example, a titanium oxide load as a percentage of the material. A preferred percentage load of titanium oxide is in the approximate range of 5% to 15%, which may vary with gauge thickness of the polyethylene sheet material. In another embodiment of the invention, the thin-film polyethylene sheet has a white pigment load of approximately 10%, containing approximately 50% titanium oxide, which was found to have no adverse effects on the polyethylene sheet material. In fact it has been discovered by the inventors that thinner gauge layers of homogeneous HDPE sheet material printed on a full exterior with white ink within the preferred titanium oxide load range had acceptable or optimized opacity for the described purposes of gift concealment as a gift bag, and for bearing additional print layers over the white print layer. Although described with reference to white pigment, any shade of pigment can be used, although lighter shades are desirable as a contrasting background for applied or printed graphics.

With a pigment-loaded polyethylene sheet material as the material of the bag 10, printing is applied to the exterior or interior surfaces of each of the panels of the bag, or at least to the two main planar panels 12 and 14, and the pleated side panels 16 and 18. Because the transparency of the sheet material of the bag even with the pigment load does not conceal the contents of the bag, printing is applied to the exterior or interior surfaces of the bag 10, or at least to the exterior or interior surfaces of each of the two main planar panels 12 and 14 and the pleated side panels 16 and 18. The printing is applied in one or two or more layers, or in adjacent or adjoining areas over the surface of the bag. This is referred to herein alternatively as the “first print layer” or “full exterior printing” or “full interior printing”, or in other words print which is applied to substantially an entire surface area of the bag, whether on the interior or the exterior as a primary print layer which decreases transparency of the bag and serves as a background for additional print layers. Within this meaning is included printing which extends over substantially an entire surface area of one or more of the described panels, but which does not extend to the very edge of a panel. This may result in connection with automated printing equipment, wherein one or more edges of the panel material which is gripped by printing equipment is not printed upon. Also, areas of panels of the bag which are to be heat-sealed such as the areas proximate to the bottom edges of the main panels, are not printed in order to avoid degradation of the strength and quality of the heat seal by the presence of printing ink.

In other versions of the bags, and depending upon the type of graphic design applied, printing may be applied not to an entire surface of one or more of the panels of the bag, but to enough of the surface area so that the bag contents are effectively concealed, even though the unprinted areas of the bag material may be transparent or translucent, as for example with thin-film white or light-colored polyethylene material. Such bags are referred to herein as having a substantial light-obstructing print pattern, which is a print pattern which does not cover the entire surface area of one or more of the panels of the bag. The bags may also be printed by a two-layer process, wherein a first or underlying or background layer is provided as a background layer which matches or compliments the color of the polyethylene sheet material, and which serves to reduce or eliminate transparency. Such a background layer or “first print layer” can be used in connection with print patterns which have larger open or unprinted areas which, without a background print layer, would be transparent. A background or first print layer is not generally needed where the decorative print pattern covers substantially all of the surface area of the panels. Also, the print density of the background or first print layer can be minimized to only the amount required to reduce or eliminate transparency of the polyethylene sheet material. This is a significant economic advantage over the alternative of increasing the thickness of the polyethylene sheet material. In other embodiments, the first print layer may consist of multiple adjacent or adjoining areas of print of different colors and shapes, which together reduce or eliminate transparency of the polyethylene sheet material. In such embodiments, because the plurality of print areas of the first print layer also form a decorative design on the gift bag, there is no need for a second or additional print layer over the first print layer. The well-known CMYK printing process is especially suitable for application of a first print layer of multiple print areas, i.e., a plurality of print areas.

The print layers or areas can be in the form of solid color ink spots with 100% coverage or CMYK process printing on the entire exterior surface. Some areas of any given print design of the full exterior printing can be in halftone screens of less than 100% ink coverage, or as much as 400% ink coverage. While the actual ink coverage density or amount may vary across the exterior or interior surfaces of the bag, the full print pattern or design(s) always substantially covers at least one of the entire exterior or interior surface of the bag, and has a density which is sufficient to decrease transparency of the polyethylene sheet material of the bag to a level which prevents visual identity of contents of the bag through the polyethylene sheet material under ambient light. The density of the print layer or layers is determined by such factors as the type, color, amount and pattern of ink applied to the polyethylene sheet material.

The first print layer may be applied as a single layer, referred to herein as a “first print layer” or “base print layer”, which provides the desired effect of reduced transparency (increased opacity) sufficient to block visibility or identity of the contents of the bag through the polyethylene sheet panels of the bag, or in multiple layers. For embodiments with multiple layers of print, there is a first or base print layer which covers the entire interior or exterior of the bag, or at least substantially the entire surface area of the two main planar panels 12 and 14 and the pleated side panels 16 and 18, and at least one additional layer (or “second print layer”) is printed over the first print layer, on any of the panels of the bag. The second print layer may extend over all or only a portion of the first print layer. In many cases, the second print layer forms decorative detail over the first print layer and therefore only resides over a portion of the first print layer. The first print layer may stop just short of the seam 21 so that the printing ink does not interfere with or diminish the strength of the seam 21 formed by heat sealing or adhesive. Even though this may leave a small area of the main panels and/or side panels without print, the bag is still regarded as having “full print” as defined herein, so long as the amount of print applied to the panels of the bag is sufficient to decrease transparency and increase opacity of the polyethylene sheet material to prevent visual identification of the bag contents through the polyethylene sheet material under ambient light.

The first print layer can be applied to either side of the polyethylene sheet material and therefore end up on the interior and/or exterior sides of the panels of the bag, and still have the desired effect of reducing or eliminating transparency. The second print layer can be applied on the same or opposite side of the polyethylene sheet material to the first print layer. Although the second print layer will in many cases be applied to the exterior surfaces only for decorative purposes, interior surface application is also possible to create bags which are decorative on the inside, either with or without a second print layer also applied to the opposite side.

In most cases the additional or second print layer is in the form of designs D which are coordinated in color or graphic design with the base or first print layer. In such embodiments, the two or more print layers constitute the full exterior printing on the bag 10. Bags with only a base or first print layer applied rely on the increased opacity provided by the base print layer to conceal the contents of the bag so that it may serve as a gift bag. Bags with a base or first print layer and one or more additional print layers have less transparency, and therefore greater opacity, as a result of the larger amount of applied printing.

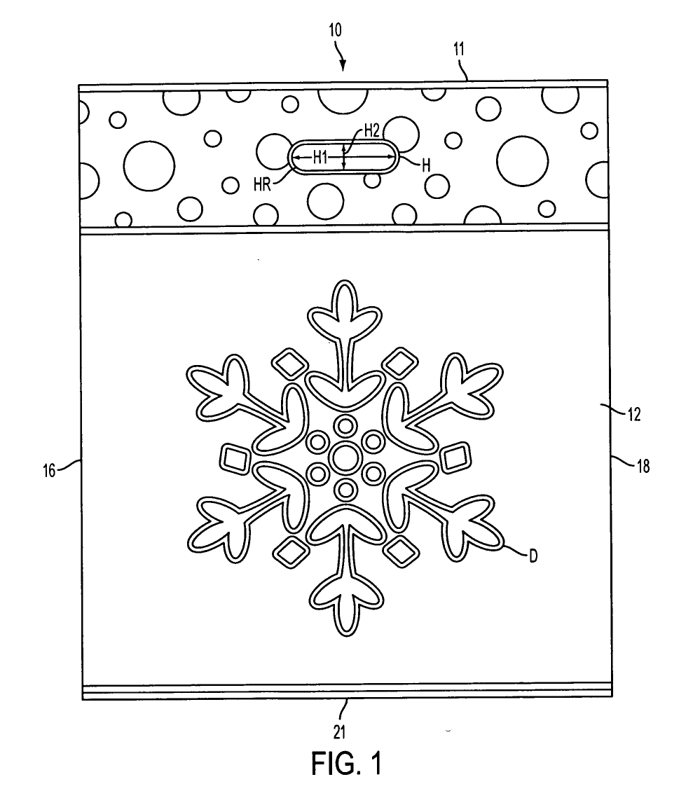

The bags can be made with structural features which work well with thin-film polyethylene sheet material. For example, as shown in FIG. 1 a handle H can be incorporated into an upper region of the two main side panels 12 and 14 in the form of an opening such as the depicted oval shape, which may have the dimensions of for example H1 in the approximate range of 80 mm to 120 mm, and H2 in the approximate range of 20 mm to 60 mm. A boundary area HR can be made of reinforced polyethylene or an encapsulated structural material such as cord or wire to increase the strength of the handle.

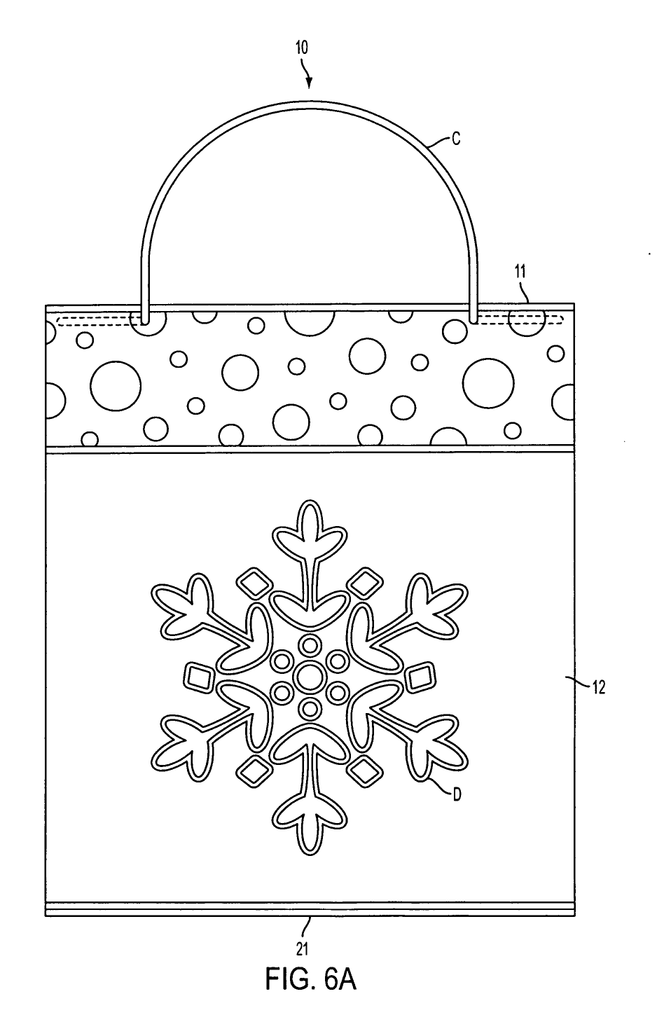

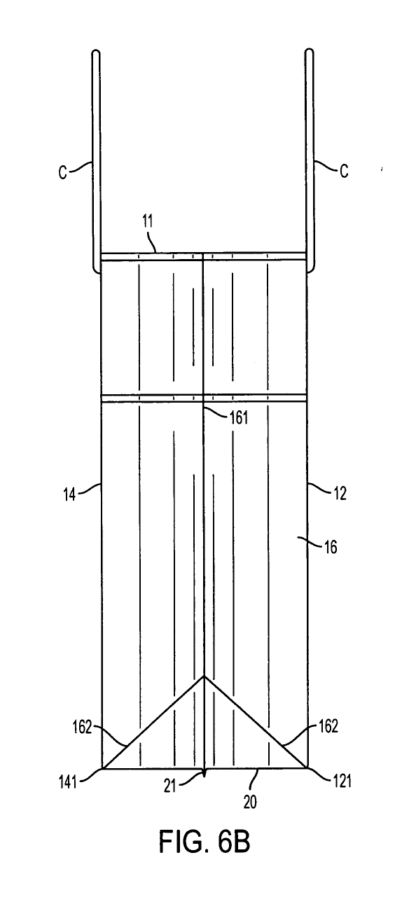

An alternate type of handle is illustrated in FIGS. 6A and 6B in the form of a cord C which extends from one or both of the main panels 12, 14. The cord C can be in the form of a plastic or textile material which is threaded through an upper region of the panels 12, 14 in the manner of a drawstring type closure to draw the open end 11 of the bag closed. Alternatively, as shown in FIG. 6B, the cord or cords C can be provided on both panels 12, 14 in the style of double handles which when gripped together keep the top of the panels 12, 14 closely aligned at the open top 11.

What is claimed as the invention is:

1. A printed gift bag for decorative containment and concealment of gifts or other contents, the printed gift bag comprising:
a bag structure made of a continuous form of polyethylene sheet material, the bag structure having two generally opposed main panels, pleated side panels formed between the main panels, the main panels and pleated side panels joined together along a common seam to form a closed bottom to the bag opposite an open top defined by aligned edges of the main panels and pleated side panels, exterior surfaces of the main panels and side panels forming an exterior surface of the bag;
a first print layer applied to an exterior surface of the bag, the first print layer having a density sufficient to decrease transparency of the polyethylene sheet material of the bag to a level which prevents visual identity of contents of the bag through the polyethylene sheet material under ambient light, and
at least one additional print layer applied over the first print layer and to an area less than an entire exterior of the bag, the additional print layer being a color different from a color of the first print layer, the additional print layer further decreasing transparency of the bag to a light transmission level less than transparency of the bag with the first print layer applied.

2. The printed gift bag of claim 1 wherein the at least one additional print layer is in the form of graphic designs located on at least one of the main panels.

3. The printed gift bag of claim 1 wherein the main panels and pleated side panels are formed as a single continuous sheet of polyethylene material and the first print layer is applied to the entire exterior of the single continuous sheet of polyethylene material.

4. The printed gift bag of claim 1 wherein the first print layer does not extend to the common seam.

5. The printed gift bag of claim 1 further comprising a handle formed in each of the main panels, and the first print layer surrounding each of the handles.

6. The printed gift bag of claim 5 wherein the handle is formed by an opening in each of the main panels proximate to the open top of the bag, and the polyethylene sheet material of the panels is reinforced proximate to the openings in the main panels.

7. The printed gift bag of claim 1 further comprising at least two additional print layers applied over the first print layer, each of the at least two additional print layers in the form of graphic designs located on at least one of the main panels and applied over less than an entire exterior surface of the bag.

8. The printed gift bag of claim 1 wherein the polyethylene sheet material comprises a blend of HDPE and LDPE.

9. The printed gift bag of claim 1 wherein the polyethylene sheet material is comprised of a blend of approximately 70% HDPE and 30% LDPE.

10. The printed gift bag of claim 1 wherein the first print layer is a color which is lighter than the additional print layer.

11. The printed gift bag of claim 1 wherein the polyethylene sheet material has a gauge thickness of 3 mils or less.

12. The printed gift bag of claim 1 wherein the common seam is formed by a heat seal of the polyethylene sheet material at an area where the first print layer and additional print layer is not applied.

13. The printed gift bag of claim 1 wherein the first print layer is of a color substantially similar to a color of the polyethylene sheet material.

14. The printed gift bag of claim 1 wherein the polyethylene sheet material includes a pigment load of titanium oxide.

15. A printed gift bag for decorative containment and concealment of gifts or other contents, the printed gift bag comprising:
a bag structure made of polyethylene sheet material and having two generally opposed main panels, two generally opposed pleated side panels extending between and connecting sides of the main panels, the main panels and pleated side panels joined together along a common seam to form a closed bottom to the bag opposite an open top defined by aligned edges of the main panels and pleated side panels, exterior surfaces of the main panels and side panels forming a surface of the bag;
a first print layer applied to a surface of the bag, the first print layer having a density sufficient to decrease or eliminate transparency of the polyethylene sheet material of the bag to a level which prevents visual identity of contents of the bag through the polyethylene sheet material under ambient light, and
a second print layer applied over the first print layer and to an area less than an entire surface of the bag, the second print layer including at least one color which is different from a color of the first print layer, the second print layer further decreasing transparency of the bag with only the first print layer applied.

16. The gift bag of claim 15 wherein the first print layer is a light color ink applied to substantially an entire surface of the bag.

17. The gift bag of claim 15 wherein the first print layer is applied to an interior surface of the bag.

18. The gift bag of claim 15 wherein the first print layer is applied to an exterior surface of the bag.

19. The gift bag of claim 15 wherein a shade of the polyethylene sheet material and a shade of the first print layer are substantially similar.

20. The gift bag of claim 15 further comprising a handle formed as an opening in at least one of the panels of the bag.

21. The gift bag of claim 15 further comprising a bottom panel formed by parallel fold lines in lower regions of the two generally opposed main panels and gusset creases in the pleated side panels.

22. The gift bag of claim 15 further comprising a drawstring closure attached proximate to the aligned edges of the two generally opposed main panels and generally opposed pleated side panels which form the open top of the bag.

23. The gift bag of claim 15 wherein the second print layer comprises two or more colors of shades different than shades of the polyethylene sheet material and the first print layer.

24. The gift bag of claim 15 wherein the first print layer is applied to an interior surface of the bag, and the second print layer is applied to an exterior surface of the bag.

25. The gift bag of claim 15 comprising a second print layer applied to interior surfaces of one or more panels of the bag.

26. The gift bag of claim 15 comprising a second print layer applied to interior and exterior surfaces of one or more panels of the bag.

27. The gift bag of claim 15 wherein the first print layer is lighter in color than the additional print layer.

28. The gift bag of claim 15 wherein the polyethylene sheet material is comprised of a blend of HDPE and LDPE.

29. The gift bag of claim 15 wherein the polyethylene sheet material is comprised of a blend of HDPE and no more than 30% LDPE.

30. The gift bag of claim 15 wherein the polyethylene sheet material has a gauge thickness of 3 mils or less.

31. The gift bag of claim 15 wherein the common seam is formed by a heat seal in an area of the polyethylene sheet material where the first print layer and additional print layer are not applied.

32. A printed gift bag for containment and concealment of gifts or other contents, the printed gift bag comprising:
a bag structure made of polyethylene sheet material, the bag structure having two generally opposed main panels, pleated side panels which extend between the main panels, the main panels and pleated side panels joined together by a common seam to form a closed bottom to the bag opposite an open top defined by aligned edges of the main panels and pleated side panels;
a first print layer applied to the polyethylene sheet material in an amount sufficient to decrease transparency of the polyethylene sheet material to a level which prevents visual identity of contents of the bag under ambient light, and
at least one additional print layer applied to the polyethylene sheet material over an area less than the first print layer, the additional print layer further decreasing transparency of the bag to a light transmission level less than transparency of the polyethylene sheet material with the first print layer applied.

33. The printed gift bag of claim 32 wherein the first print layer is applied to the polyethylene sheet material on an interior surface of the bag.

34. The printed gift bag of claim 32 wherein the first print layer is applied to the polyethylene sheet material on an exterior surface of the bag.

35. The printed gift bag of claim 32 wherein a color of the first print layer is of a shade similar to a color of the polyethylene sheet material.

36. The printed gift bag of claim 32 wherein the additional print layer defines graphical images with the first print layer as a background to the graphical images.

37. The printed gift bag of claim 32 wherein the additional print layer includes colors different than colors of the polyethylene sheet material and the first print layer.

38. The printed gift bag of claim 32 further comprising gusset folds in the pleated side panels which extend from a center fold of each pleated side panel to edges of the pleated side panels and to edges of a bottom panel.

39. The printed gift bag of claim 32 further comprising a handle formed in one or both of the two generally opposed main panels.

40. The printed gift bag of claim 32 wherein the first print layer is applied to substantially an entire surface area of the polyethylene sheet material of the two generally opposed main panels.

41. The printed gift bag of claim 32 wherein the first print layer is applied to one side of the polyethylene sheet material, and the additional print layer is applied to an opposite side of the polyethylene sheet material.

42. The printed gift bag of claim 32 wherein the additional print layer covers a lesser surface area of the polyethylene sheet material of the bag than the first print layer.

43. The printed gift bag of claim 32 wherein the polyethylene sheet material includes a pigment load of titanium oxide.

44. The printed gift bag of claim 31 wherein the pigment load of titanium oxide is in the approximate range of 5% to 15% of the total material.

45. The printed gift bag of claim 31 wherein the polyethylene sheet material has a white pigment load of approximately 10%, wherein the white pigment load contains approximately 50% titanium oxide.

46. A printed gift bag made of polyethylene sheet material of a blend of HDPE and LDPE and a gauge thickness of 3 mils or less, the gift bag having two generally opposed main panels, adjoining side panels and an adjoining bottom, the panels forming an exterior surface of the gift bag, and a print layer applied to the exterior surface of the gift bag, the print layer having a density sufficient to decrease transparency of the polyethylene sheet material of the gift bag to a level which prevents visual identity of contents of the bag under ambient light.

47. The printed gift bag of claim 46 wherein the polyethylene sheet material includes a pigment load of titanium oxide in an amount sufficient to decrease transparency of the polyethylene sheet material to a level which prevents visual identity of contents of the gift bag under ambient light.

48. The printed gift bag of claim 46 wherein the print layer is applied to the entire exterior surface of the gift bag.

49. The printed gift bag of claim 46 wherein the print layer is formed from a plurality of printed areas.

50. The printed gift bag of claim 46 wherein the blend of HDPE and LDPE contains 30% or less LDPE.

51. The printed gift bag of claim 46 wherein the blend of HDPE and LDPE is approximately 70% HDPE and 30% LDPE.

52. The printed gift bag of claim 46 wherein the blend of HDPE and LDPE is approximately 76% HDPE and 24% LDPE.
